(19) United States
(12) Patent Application Publication
(10) Pub. No.: US 2010/0172606 A1
(43) Pub. Date: Jul. 8, 2010

(54) METHOD FOR THE PRODUCTION OF A ROLLER BEARING WITHOUT MACHINING

(75) Inventors: Erich Lunz, Lonnerstadt (DE); Ralph Painta, Hagenbuechbach (DE); Peter Schuster, Zirndorf (DE); Horst Doeppling, Herzogenaurach (DE)

Correspondence Address: LUCAS & MERCANTI, LLP, 475 PARK AVENUE SOUTH, 15TH FLOOR, NEW YORK, NY, 10016, US

(73) Assignee: SCHAEFFLER KG, Herzogenaurach (DE)

(21) Appl. No.: 12/664,212

(22) PCT Filed: Feb. 7, 2008
(86) PCT No.: PCT/DE2008/000241

§ 371 Date: Dec. 11, 2009

(30) Foreign Application Priority Data
Jun. 13, 2007 (DE) 10 2007 027 216.4

(51) Int. Cl. F16C 19/04; B21D 53/10; B21D 22/00

(52) U.S. Cl. 384/490; 29/898.061; 72/347

(57) ABSTRACT

The invention relates to a method for the production of a roller bearing (5) which does not require machining, wherein the roller bearing (5) has a bearing inner ring and a bearing outer ring (3a′, 3b′) and at least one rolling body row (9) guided between said rings in raceways (8a, 8b). In order to be able to implement the production of the bearing rings (3a′, 3b′) including the raceways (8a, 8b) for the rolling bodies (9) according to a forming method which does not involve machining, in a manner which is more cost-effective with respect to known production methods, a ring element (3) is initially produced from a sheet metal blank (1) by means of dies and pressure forming, the ring element having a section (3a) lying radially on the inside, a ring-shaped section (3b) lying radially on the outside, and having a central recess (4), raceways (8a, 8b), and preferably a set breaking point (6) between the two ring-shaped sections (3a, 3b). Next, the ring element (3) is formed without machining by means of deep-drawing and is equipped with rolling bodies (9) in such a manner that a complete and undetachably assembled component group is produced in the form of a roller bearing (5).

### FIELD OF THE INVENTION

The invention relates to a method for the non-cutting production of a rolling bearing with a bearing inner ring and a bearing outer ring and with at least one rolling body row guided between these in raceways. The invention relates, furthermore, to a stamping and deep-drawing tool for applying the method and also to a single-row or multiple-row grooved ball bearing produced according to the method.

### BACKGROUND OF THE INVENTION

It is already known to produce the bearing rings of a rolling bearing in a non-cutting manner according to a cost-effective deep-drawing method. Regions which have been recognized as problematic are the groove-shaped ball raceways or the undercuts required, above all in radial or grooved ball bearings, which cannot be produced by conventional deep-drawing or forming methods.

In order to overcome this problem, instead of grooved ball bearings, axially prestressed four-point bearings or angular ball bearings, both in a single row and in a two-row version, are favored (see DE 2 334 305 A, DE 26 36 903 A1, DE 87 02 275 U1, DE 10 2004 038 709 A1, EP 1 683 978 A1). In four-point bearings, either the bearing inner ring or the bearing outer ring is then divided or produced so as to consist of two drawn components. The undercut in the respective opposite raceway is then generated mostly by roller-burnishing or another identically acting production method. What has become apparent as a disadvantage in four-point bearings with split bearing rings and in angular ball bearings is that, as already indicated above, these bearings have to be prestressed axially. Moreover, the angular ball bearings have comparatively lower load-bearing capacity in applications where mainly radial loads occur.

Further, it is known to manufacture the inner rings and outer rings of the bearings from separate semifinished products, such as sheet bars or else ring elements, and to complete them with at least one rolling body row during assembly. Thus, GB 1,137,313 describes a method for producing a ball bearing, in which the bearing inner ring and the bearing outer ring are manufactured from different sheet bars in a non-cutting manner.

Moreover, it is known to produce both a bearing inner ring and bearing outer ring from a single common semifinished product, with the result that cost savings are to be noted. Thus, DE 21 53 597 A describes a method for the production of rolling bearing rings from sheet metal, according to which, first, a ring of U-shaped cross section, consisting of two essentially axially directed legs of different diameter which are connected to one another by means of a circumferential web, is manufactured in a non-cutting manner, and in which, subsequently, the web is divided so as to give rise to a bearing inner ring and a bearing outer ring. In a following operation, the raceways for the rolling bodies are then formed into the bearing inner ring and bearing outer ring in an extremely complicated manner by means of an elastically expandable punch, that is to say by means of a punch capable of being acted upon with a pressure medium.

Furthermore, DE 602 09 662 T2 discloses a production method for an inner ring and an outer bearing ring of a rolling bearing, first a disk being cut off from a cylindrical bar material, and both a ring for a bearing inner ring and a ring fora bearing outer ring being produced in a non-cutting manner from said disk by cold forging and the subsequent stamping out of a central circular orifice and of an annular groove. The required ring raceways for guiding the rolling bodies are generated by means of subsequent cutting machining.

Finally, patent publication AT 185 664 discloses a method for the simultaneous non-cutting production of an outer and an inner bearing ring for rolling bearings, these bearing rings being worked out of a common disk-shaped blank in a plurality of drawing operations and finally being separated from one another. Thereafter, the bearing rings are provided with raceways, for example by roller-burnishing, and subsequently, completed with at least one rolling body row, are assembled into a rolling bearing.

### OBJECT OF THE INVENTION

Proceeding from this, the object on which the invention is based is to present a method for the non-cutting production of a rolling bearing with a bearing inner ring and a bearing outer ring, which method makes it possible, as compared with the known production methods, to have a more cost-effective manufacture of the bearing rings, including their raceways, for the rolling bodies by means of a non-cutting forming method.

### SUMMARY OF THE INVENTION

According to the features of the main claim, the invention proceeds from a method for the non-cutting production of a rolling bearing with a bearing inner ring and a bearing outer ring and with at least one rolling body row guided between these in raceways. The set object is achieved by means of the following method steps to be carried out:
a) provision of a metal sheet bar;
b) stamping of a ring element out of the metal sheet bar, which ring element has a radially inner annular portion for a bearing inner ring and a radially outer annular portion for a bearing outer ring;
c) formation of at least one predetermined breaking point in the connection region between the two annular portions;
d) formation of annular raceways for the at least one rolling body row by means of the axial press forming of the two annular portions;
e) support of the ring element both in the region of the inside diameter of the radially inner annular portion and in the region of the outside diameter of the radially outer annular portion and forming of the ring element by the axial application of force to the annular portions in the connection region or in the region of the formed predetermined breaking point, in such a way that the two annular portions and the annular raceways of these are pivoted toward one another about the connection region or about the predetermined breaking point;
f) introduction of at least one cage element equipped with the at least one rolling body row into the radial spacing formed between the two annular portions moved toward one another; and
g) final transfer of the two annular portions, including the cage element, together with the rolling body row, by the further application of force to the end faces of the annular portions and/or to the rolling body row into an end position such that a complete captively mounted subassembly, consisting of a bearing inner ring and of a bearing outer ring, with annular raceways which are arranged radially opposite one another and in which the at least one rolling body row is received positively, is formed.

The subclaims describe preferred developments or refinements of the invention.

Accordingly, with regard to method step a), a metal sheet bar may advantageously be used which, in the region of the ring element to be stamped out, has different material thicknesses as a function of the material flow to be expected and/or of the degree of forming and/or of the material to be processed.

Furthermore, it may be expedient to carry out method steps b) to d) in one single common operation.

Furthermore, with regard to method step c), according to a first advantageous design variant of the method, a predetermined breaking point may be formed in the form of a plurality of segment-like webs of the ring element which are arranged over the circumference and which are themselves separated from one another by means of perforations.

According to a further design variant, with regard to method step c), a predetermined breaking point may be formed in the form of a material weakening continuous or partially segmented over the circumference.

A combination of the above design variants is likewise possible and is therefore also covered by the invention.

In another variant, for method step c), no such predetermined breaking point is formed in the ring element, but, instead, the radially inner portion and the radially outer portion are separated completely from one another.

One advantageous realization of the method provides for method step d), that the axial press forming is executed by means of a simple embossing of the raceways. In embossing, stresses making secondary treatment necessary may arise in the material of the ring elements.

Alternatively or additionally to this, one advantageous realization of the method provides for method step d), that the axial press forming comprises deep-drawing or extrusion. In these method steps, a material flow occurs which compensates mechanical stresses. Furthermore, the material flow may be utilized not only for transferring the raceway to that side of the ring element which points toward the tool, but also for causing that side of at least one of the two annular portions which points away from the tool to acquire a contour.

In particular, for this purpose, at least one of the two ring elements may be introduced into a die, so that, during axial press forming, the ring element is pressed into the die and that side of the ring element which points away from the tool acquires a contour which corresponds to the cross-sectional configuration of the die. In this case, in a single method step, both the raceway on the side which points toward the tool and the contour on that side of the ring element which points away from the tool can be obtained. At the same time, during axial press forming, the material flow reduces the occurrence of mechanical stresses in the ring element.

As the invention further provides, with regard to method step e), the forming of the ring element is carried out by the axial application of force to the annular portions, for example in the connection region or in the region of the formed predetermined breaking point, preferably in a plurality of forming stages.

As the invention also provides, with regard to method step e), a deep-drawing tool with a drawing punch which is annular or has at least part-annular portions and with an annular drawing die is used.

Advantageously, in this case, a drawing punch is used, with a portion tapering in cross section toward the workpiece in the form of the ring element and having radially inwardly and radially outwardly pointing junction surfaces which, in turn, penetrate into the ring element in the region of the predetermined breaking point and thereby implement forming as a result of a combination of a radial driving apart of the two annular portions and of a simultaneous axial introduction of these into the annular drawing die.

With regard to method step f), the introduction of the at least one cage element equipped with the at least one rolling body row into the axial spacing forming between the two annular portions moving toward one another may take place manually, semi-automatically or fully automatically.

With regard to method step g), there may be a provision whereby, advantageously, at the latest after the end position has been reached, the predetermined breaking point between the two annular portions in the form of the produced bearing inner ring and bearing outer ring breaks.

Advantageously, further, there may be provision whereby the complete captively mounted rolling bearing subassembly is subjected to heat treatment in order to eliminate structural stresses in the bearing inner ring and the bearing outer ring which have occurred due to the forming process.

Alternatively to the method steps described hitherto, there may be provision whereby, according to the method, a rolling bearing without a cage is produced for the rolling bodies. In this case, method step f) comprises the introduction of rolling bodies into the radial spacing forming between the two annular portions moved toward one another, and method step g) comprises the final transfer of the two annular portions, including the rolling bodies, by the further application of force to the end faces of the annular portions and/or to the rolling bodies into an end position such that a complete captively mounted subassembly, consisting of a bearing inner ring and of a bearing outer ring, with annular raceways which are arranged radially opposite one another and in which the at least one rolling body row is received positively, is formed.

Finally, alternatively to the method sequence described hitherto, there may be provision whereby only one of the two said ring elements is produced according to the method steps mentioned, whereas the second ring element is produced according to the same or another, for example conventional, forming process and is conveyed to the manufacturing device before being filled with the rolling bodies.

Finally, the subject of the invention includes a stamping and deep-drawing tool for carrying out the method described above and also a single-row or multiple-row grooved ball bearing produced according to the above method.

The proposed method for producing a rolling bearing has the essential advantage, in relation to conventional production methods, that the bearing inner ring and the bearing outer ring, including the undercut for the rolling body raceways, are produced as it were simultaneously in one production process by the non-cutting forming method. Furthermore, this method makes it possible, even while the bearing rings are being produced by said non-cutting forming method, to equip these with at least one cage element having at least one rolling body row or, without a cage, with the necessary rolling bodies and finally to connect them positively to form a complete captively mounted subassembly. This method therefore results in a considerable potential for savings in terms of material and work time.

### BRIEF DESCRIPTION OF THE DRAWINGS

The invention is explained in more detail below by means of some embodiments, with reference to the accompanying drawing in which:

FIG. 1 shows an initial metal sheet bar or disk-shaped blank for producing a rolling bearing according to the method, in a perspective view, according to method step a);

FIG. 2 shows a suitable stamping tool for carrying out the method steps b) and c) in a sectional view;

FIG. 3 shows a metal sheet bar machined according to method steps b) and c) in the form of a ring element, in a perspective view;

FIG. 4 shows a suitable deep-drawing tool for carrying out method step d) in a sectional view;

FIG. 5 shows a ring element machined according to method step d), in a perspective view;

FIG. 6 shows a suitable deep-drawing tool for carrying out method step e) in a sectional view, at a time point t₀;

FIG. 7 shows the deep-drawing tool according to FIG. 6 during operation, at a time point t₁;

FIG. 8 shows the deep-drawing tool according to FIG. 6 during operation, at a time point t₂;

FIG. 9 shows the formed ring element at the time point t₂ in a perspective view;

FIG. 10 shows the deep-drawing tool according to FIG. 6 during operation, at a time point t₃;

FIG. 11 shows the formed ring element at the time point t₃ in a perspective view;

FIG. 12 shows the deep-drawing tool according to FIG. 6 during operation, at a time point t₄;

FIG. 13 shows the formed ring element at the time point t₄ in a perspective view;

FIG. 14 shows the equipping of the formed ring element at a time point t₅ with a rolling body row, here illustrated by a cage element;

FIG. 15 shows further machining by the forming of the ring element at a time point t₆;

FIG. 16 shows the finished formed ring element in the form of a rolling bearing, equipped here with a cage element having a rolling body row, in the forming tool, at a time point t₇;

FIG. 17 shows the removal of the rolling bearing from the forming tool at a time point t₈;

FIG. 18 shows the finished rolling bearing in an individual perspective illustration;

FIG. 19 shows a sectional illustration of alternatively carrying out method step d) in two part images; and

FIG. 20 shows a sectional view of a rolling bearing produced by method step d) from FIG. 19 after the method has been further carried out.

### DETAILED DESCRIPTION OF THE DRAWINGS

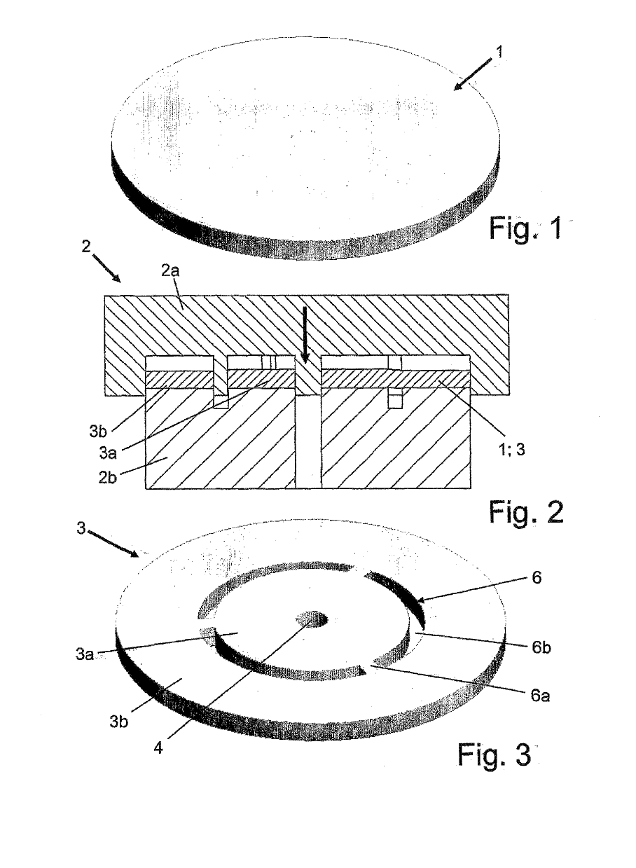

FIG. 1 thus shows a semifinished product in the form of a metal sheet bar 1 of already circular shape, which may already have the outer dimensions, such as diameter, and material thicknesses for a subsequent non-cutting machining by stamping and forming.

As already mentioned, according to FIG. 2, in the method a ring element 3 first has to be stamped out from the metal sheet bar 1 by means of a stamping tool 2 known per se with a punch 2a and with a counterpunch 2b, which ring element has a radially inner annular portion 3a with a centric recess 4 and a radially outer annular portion 3b.

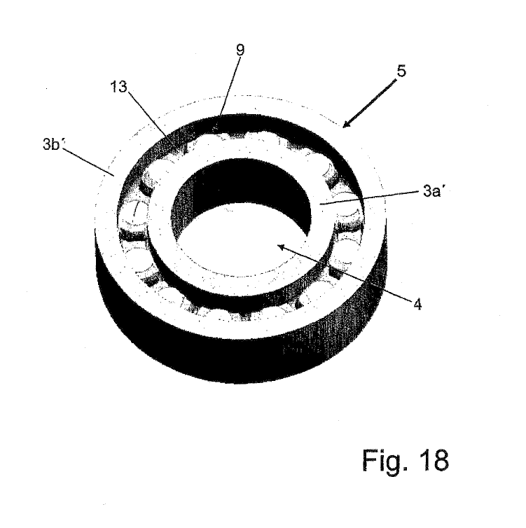

The radially inner annular portion 3a is, in future, to form the bearing inner ring 3a′ and the radially outer annular portion 3b the bearing outer ring 3b′ of a rolling bearing 5 (FIG. 2; FIG. 18).

During forming by stamping, in the connection region between the two annular portions 3a and 3b of the ring element 3 according to FIG. 3, a predetermined breaking point 6 is preferably incorporated into the latter and in the present case is formed by a plurality of segment-like webs 6a which are arranged over the circumference and which are themselves separated from one another by means of perforations 6b.

By contrast, it may also be expedient to provide (not illustrated in any more detail) a continuous or partially segmented material weakening only over the circumference in the ring element 3. A combination of the two above design variants is likewise possible and is therefore also covered by the invention.

According to another variant, it is also possible that no such predetermined breaking point 6 is formed in the ring element 3, but, instead, the radially inner portion 3a and the radially outer portion 3b are separated completely from one another. Such a procedure is to be preferred when the ring element 3 according to FIG. 3 is not to be separately stored intermediately and/or brought to another manufacturing machine. In such a case, the separate radially inner portion 3a and the separate radially outer portion 3b remain in a combined stamping and forming tool 2, 10 for subsequent forming and equipping with rolling bodies and for final forming (not illustrated).

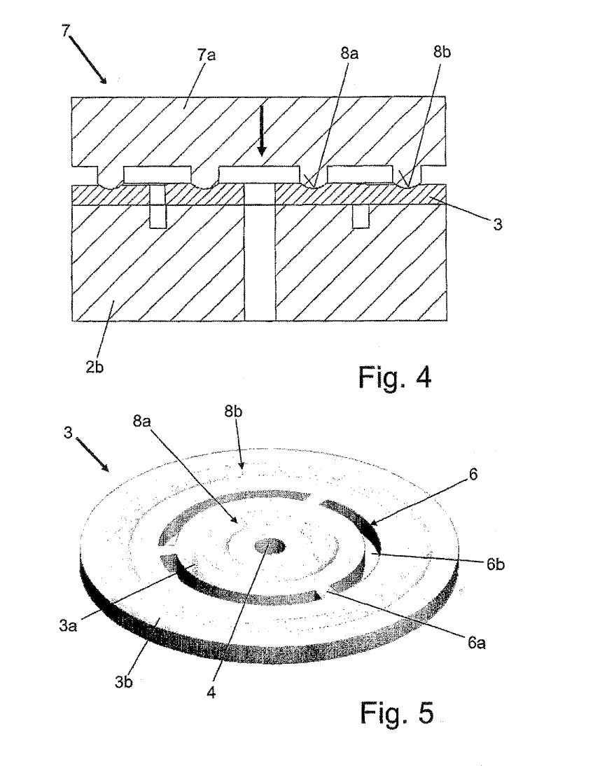

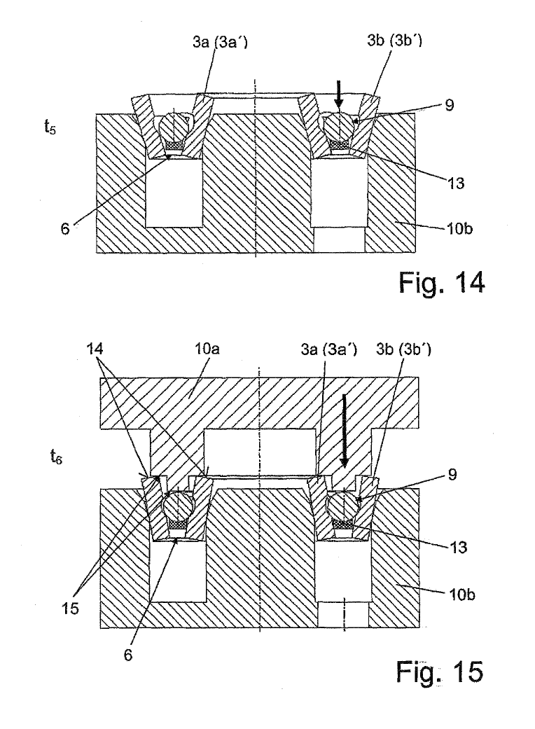

After the method steps explained with reference to FIGS. 1 to 3, according to FIGS. 4 and 5, annular raceways 8a and 8b for at least one rolling body row 9 of the rolling bearing 5 (cf., FIGS. 14 to 18), are formed axially into the annular portions 3a, 3b of the ring element 3 by means of a press-forming tool 7 with suitable press punch 7a.

A person skilled in the art, with knowledge of the invention, can comprehend that it is expedient to carry out all the method steps described above in one single common operation, for which purpose the forming tool merely has to be adapted correspondingly, that is to say equipped both with a stamping means and with a press-forming means (not illustrated in any more detail).

Furthermore, it has proved highly appropriate in investigations to use a metal sheet bar 1 which, in the region of the ring element 3 to be stamped out, has different material thicknesses as a function of the material flow to be expected and/or of the degree of forming and/or of the material to be processed. The profiling of the ring element 3, in particular of the raceways 8a, 8b, is therefore designed in such a way that uniform raceways 8a, 8b are produced in a finally formed part.

In that regard, preferably both the material flow to be expected and the degree of forming during forming must previously be simulated mathematically and taken into account correspondingly. Thus, during the further forming, still to be described below, by the axial shaping of the ring element 3 or its annular portions 3a, 3b, the regions which are upset must have smaller material thicknesses, while the regions which are stretched therefore have greater material thicknesses. A possible stretching of the raceways 8a, 8b during said shaping must therefore be taken into account and be allowed for in the initial profiling.

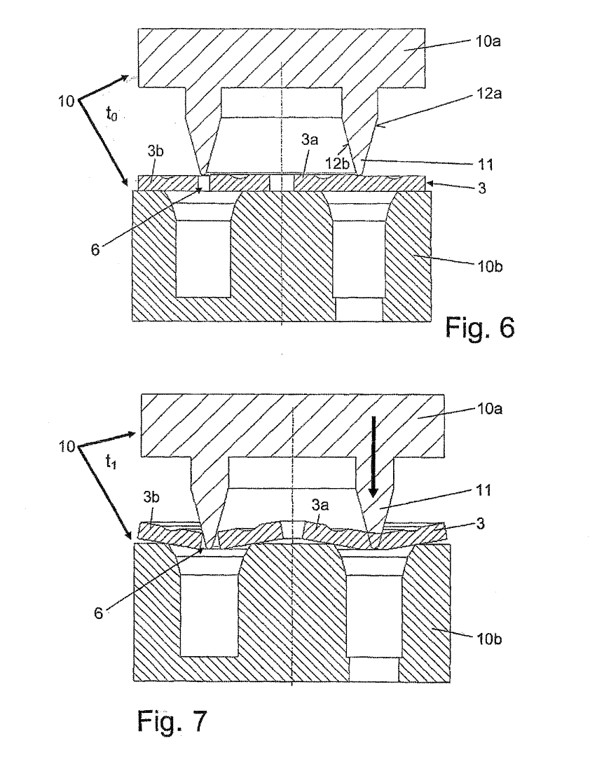

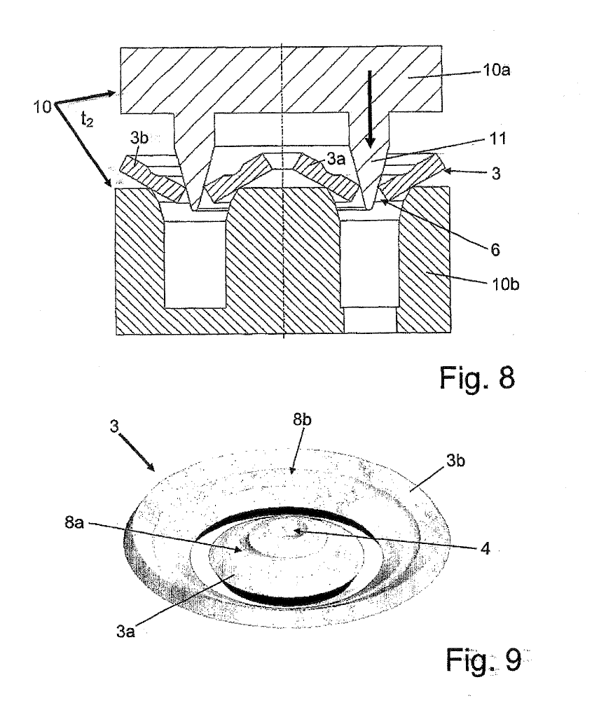

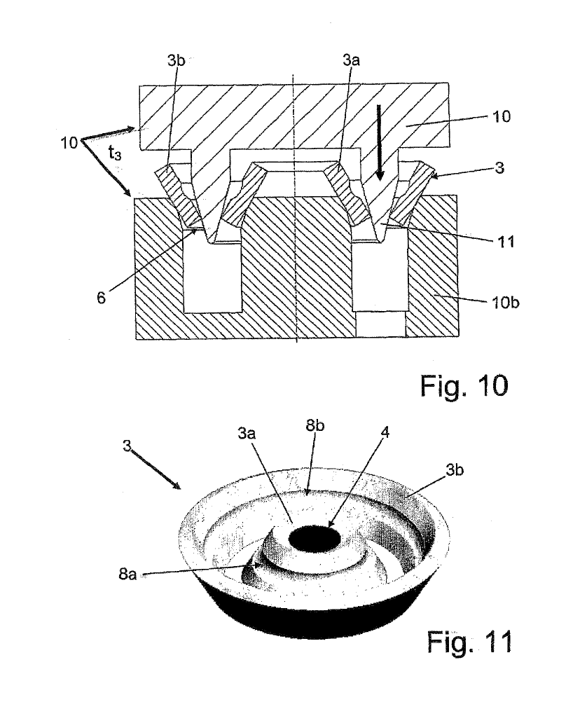

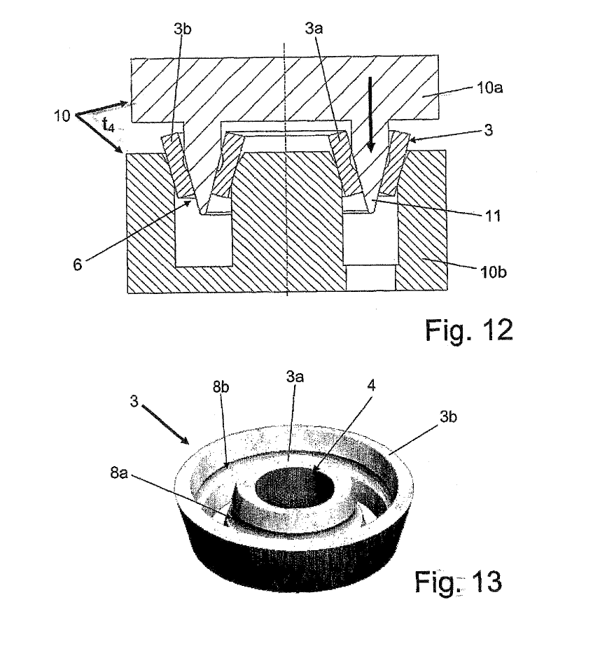

As already indicated above, the ring element 3 is then subjected to axial forming by deep drawing, according to FIGS. 6, 7, 8, 10 and 12 a deep-drawing tool 10 with a drawing punch 10a which is annular or has at least part-annular portions and with an annular drawing die 10b being used.

The drawing punch 10a is designed with a portion 11 tapering in a wedge-shaped manner in cross-section toward the workpiece or toward the ring element 3 and having radially inwardly and radially outwardly pointing junction faces 12a, 12b which, in turn, penetrate in the region of the predetermined breaking point 6 between the annular portions 3a, 3b of the ring element 3 into the latter and thereby implement forming as a result of a combination of a radial driving out of the two annular portions 3a, 3b and of a simultaneous axial introduction of these into the drawing die 10b.

In this case, the ring element 3 is supported on the drawing die 10b both via a region near its inside diameter and via regions near its outside diameter, as a result of which, because of the axial application of force, described in more detail above, to the predetermined breaking point 6 and to the adjacent surfaces of the annular portions 3a, 3b of the ring element 3, these and their raceways 8a, 8b are pivoted toward one another about the predetermined breaking point 6. The predetermined breaking point 6 or the material still present in this region in this case forms as it were a kind of solid state joint.

According to FIGS. 6 to 13, this intentional forming of the ring element 3 in one or more forming steps is carried out in the present case in a period of time t₀ to t₄.

When a specific predetermined degree of forming of the ring element 3 or its annular portions 3a, 3b is reached at the time point tₛ, according to FIG. 14 a cage element 13 equipped with rolling bodies 9 is introduced manually or semi-automatically or fully automatically in the present case into the radial spacing then forming between the two annular portions 3a, 3b moved toward one another, together with the incorporated raceways 8a, 8b or with the bearing inner ring 3a′ and bearing outer ring 3b′, being formed, of the future rolling bearing 5.

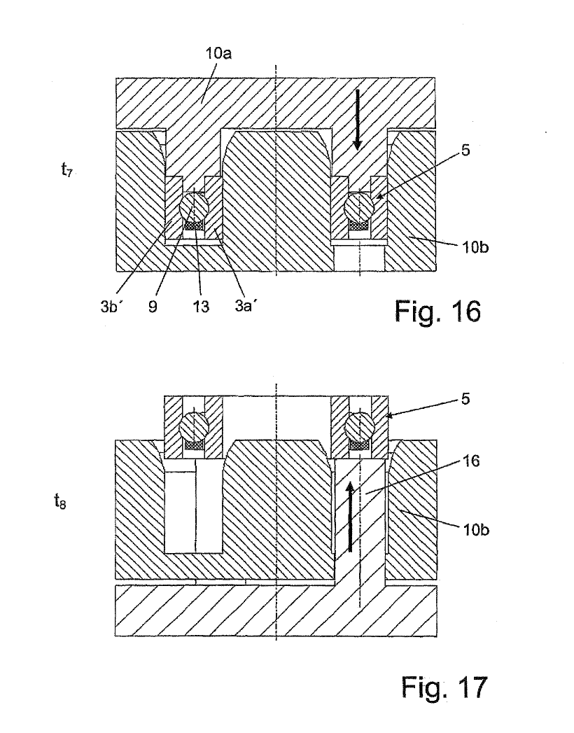

On account of a subsequent further application of force to the adjacent end faces 14 of the annular portions 3a, 3b and/or to the rolling bodies 9 by means of a drawing punch 10a now designed with obtuse pressure surfaces 15, the composite component structure to be generated is transferred at a time point t₆ into an end position within the drawing die 10b such that finally, at a time point t₇, a complete and captively mounted subassembly in the form of a rolling bearing 5 is formed, consisting of a bearing inner ring 3a′ and of a bearing outer ring 3b′ with annular raceways 8a, 8b which are arranged radially opposite one another and in which the rolling bodies 9, together with the cage element 13, are received positively (see, FIGS. 15 and 16).

At the latest when the end position shown in FIG. 16 is reached, the predetermined breaking point 6 between the two annular portions 3a, 3b or between the produced bearing inner ring and bearing outer ring 3a′, 3b′ breaks.

As illustrated in more detail in FIG. 17, at a time point t₈ the rolling bearing 5 is conveyed axially out of the drawing die 10b by means of a push-out punch 16 of the deep-drawing tool 10 and, according to FIG. 18, can be subjected as a complete rolling bearing subassembly (rolling bearing 5) to a suitable heat treatment in a proven way known per se.

As may be gathered from FIGS. 14 to 18, the rolling bearing 5 is preferably a single-row grooved ball bearing. However, according to the above method, a multiple-row grooved ball bearing or any other single-row or multiple-row rolling bearing 5 known per se, with a bearing inner ring and bearing outer ring 3a′, 3b′ can also be produced, in order to replace conventionally constructed rolling bearings know per se. In this respect, reference is made, by way of example, to cylindrical rolling bearings or needle bearings.

As has already been indicated briefly in the summary of the invention, a rolling bearing may also be produced so as to be cageless, that is to say, for example, with a full set of balls, according to the basic principles of the method presented. For this purpose, the rolling bodies 9 without a cage 13 are introduced into the radial spacing forming between the two annular portions 3a and 3b moved toward one another. This is followed by the transfer of the two annular portions 3a, 3b, including the rolling bodies 9, by a further application of force to the end faces 14 of the annular portions 3a, 3b and/or to the rolling bodies 9 into an end position such that a complete captively mounted subassembly, consisting of a bearing inner ring 3a′ and of a bearing outer ring 3b′, with annular raceways 8a and 8b which are arranged radially opposite one another and in which the at least one rolling body row is received positively, is formed. In that regard, reference is made to FIGS. 1 to 13 in full and to FIGS. 14 to 18 only insofar as the installation of the rolling body cage 13 shown there is dispensed with.

Moreover, alternatively to the method variant described in detail with reference to the figures, there may be provision whereby only one of the two said ring elements for forming the bearing inner ring 3a′ or the bearing outer ring 3b′ is produced according to the method steps mentioned, whereas the second ring element is produced according to the same or another, for example conventional, forming process and is conveyed to the manufacturing apparatus before the introduction of the rolling bodies 9 and before the joint forming into the rolling bearing to be produced. In that regard, FIGS. 9 to 18 illustrate the method steps which then follow and have already been described further above.

In the exemplary embodiment described above, a press-forming tool 7 was provided for the method step d) (see, FIG. 4), which has a press punch 7a, and therefore the axial press forming to produce the raceways 8a, 8b of the annular portions 3a, 3b comprised a pressing of the press punch 7a.

Alternatively or additionally to this, for method step d) there may be provision for carrying out the axial press forming by means of deep drawing or extrusion or for superposing deep drawing or extrusion upon the pressing indicated in FIG. 4.

FIG. 19 shows a cross section through a ring element 3 which was previously produced according to method steps a) to c) and the two annular portions 3a, 3b of which are introduced into a die 17 (upper part image). For the two annular portions 3a, 3b, the die 17 has a similarly configured cross-sectional contour 18 which comprises a horizontal portion 19, a first vertical portion 20, a shoulder region 21 and a second vertical portion 22. The portions 19 to 22 are mirror-symmetrical with respect to an imaginary axis which intersects the cross-sectional contour 18 perpendicularly to the surface of the die 17.

As illustrated in the upper part image of FIG. 19, the two annular portions 3a, 3b of the ring element 3 are introduced into the cross-sectional contour 18 of the die 17 in such a way that these are supported by the shoulder region 21.

Axial press forming is carried out by means of a tool which on its end face has in each case a dome-shaped protuberance 23 which in each case bears centrally on the two portions 3a, 3b. By axial force (arrow 24) being exerted on the tool, the domes 23 are pressed onto the portions 3a, 3b which, in turn, are pressed into the cross-sectional contour 18 of the die 17. In this case, a material flow in the direction of the axial force 24 and perpendicularly thereto takes place, so that the portions 3a, 3b fill the cross-sectional contour 18 of the die 17 (see, FIG. 19, lower part image). On the side of the portions 3a, 3b which faces the tool, the respective annular raceway 8a, 8b is formed by the dome-shaped protuberances, and, on the side facing away from the tool, a contour 25 is formed which corresponds to the cross-sectional contour 18 of the die 17.

Further machining takes place after the steps described above with regard to the first exemplary embodiment.

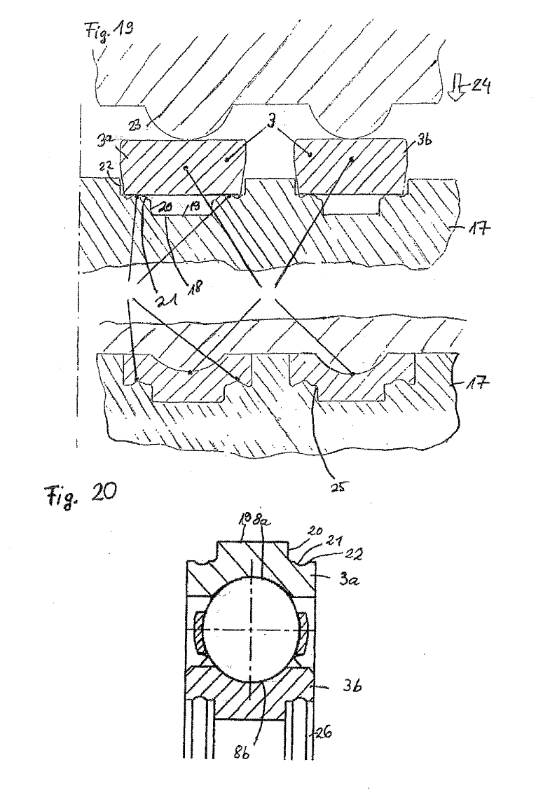

FIG. 20 shows the result of the portion 3a, 3b formed in method step d), as in FIG. 19. The rolling bearing has, in addition to annular raceways 8a, 8b on the inner surface area of the respective bearing rings and on the outer surface areas, a contour 25 which is determined by the configuration of the cross-sectional contour 18 of the die 17. The horizontal portion 19 in this case serves the rolling bearing for bearing against a bearing receptacle, not illustrated in any more detail; the contouring given by the portions 20, 21 and 22 serves for the connection to the bearing receptacle. The connection may be formed, for example, by pins 26 which fit into the contouring.

In the second exemplary embodiment, the raceways 8a, 8b and the contour 25 were produced in a single method step d), so that secondary machining, even thermal secondary machining for the reduction of mechanical stresses which have occurred in the material, can be avoided.

### REFERENCE SYMBOLS

1 Metal sheet bar
2 Stamping tool
2a Punch
2b Counter punch
3 Ring element
3a Radially inner annular portion
3b Radially outer annular portion
3a′ Bearing inner ring
3b′ Bearing outer ring
4 Recess
5 Rolling bearing
6 Predetermined breaking point
6a Webs
6b Perforations
7 Press-forming tool
7a Press punch
8a Annular raceway
8b Annular raceway
9 Rolling body, rolling body row
10 Deep-drawing tool
10a Drawing punch
10b Drawing die
11 Portion tapering in a wedge-shaped manner of drawing punch 10a
12a Junction surface on drawing punch 10a
12b Junction surface on drawing punch 10a
13 Cage element
14 End faces of the annular portions 3a, 3b
15 Obtuse pressure surfaces on drawing punch 10a
16 Push-out punch
17 Die
18 Cross-sectional contour
19 Horizontal portion
20 First vertical portion
21 Shoulder region
22 Second vertical portion
23 Protuberance
24 Axial force
25 Contour
26 Pin

1. A method for non-cutting production of a rolling bearing having a bearing inner ring, and a bearing outer ring and at least one rolling body row guided between the bearing inner ring and the bearing outer ring in raceways, comprising the following steps:
a) providing a metal sheet bar;
b) stamping a ring element out of the metal sheet bar, the ring element having two annular portions, a radially inner annular portion for a bearing inner ring and a radially outer annular portion for a bearing outer ring;
c) forming at least one predetermined breaking point in a connection region between the two annular portions;
d) forming annular raceways for the at least one rolling body row by means of axial press forming of the two annular portions;
e) supporting the ring element both in a region of an inside diameter of the inner annular portion and in a region of an outside diameter of the radially outer annular portion and forming of the ring element by an axial application of force to the two annular portions in the connection region or in a region of the formed predetermined breaking point, in such a way that the two annular portions and the annular raceways of the two annular portions are pivoted toward one another about the connection region or about the breaking point;
f) introducing at least one cage element equipped with the at least one rolling body row into the radial spacing formed between the two annular portions moved toward one another; and
g) transferring the two annular portions, including the cage element, together with the at least one rolling body row, by a further application of force to end faces of the two annular portions and/or to the at least one rolling body row into an end position such that a complete captively mounted subassembly, comprising a bearing inner ring and a bearing outer ring, with annular raceways which are arranged radially opposite one another and in which the at least one rolling body row is received positively, is formed.

2. The method of claim 1, wherein, with regard to method step a), the metal sheet bar, in the region of the ring element to be stamped out, has different material thicknesses as a function of the material flow, of forming and/or processing.

3. The method of claim 1, wherein method steps b) to d) are carried out in one single common operation.

4. The method of claim 1, wherein, with regard to method step c), the predetermined breaking point is formed as a plurality of segment-like webs which are arranged over a circumference of the ring element and which are separated from one another by means of perforations.

5. The method as of claim 1, wherein, with regard to method step c), the predetermined breaking point in the form of a material weakening, continuous or partially segmented over a circumference, is formed.

6. The method of claim 1, wherein no predetermined breaking point is formed in the ring element, but, instead, the radially inner portion and the radially outer portion are separated completely from one another.

7. The method of claim 1, wherein, with regard to method step e), the forming of the ring element is carried out by the axial application of force to the two annular portions in the connection region or in the region of the formed predetermined breaking point in a plurality of forming stages.

8. The method of claim 1, wherein, with regard to method step e), a deep-drawing tool having a drawing punch, which is annular or has at least part-annular portions, and an annular drawing die is used.

9. The method of claim 1, wherein a drawing punch is used, with a portion tapering in cross-section toward a workpiece in the form of the ring element and having radially inwardly and radially outwardly pointing junction surfaces which, in turn, penetrate into the ring element in the region of the predetermined breaking point and thereby implement forming as a result of a combination of a radial driving apart of the two annular portions and of a simultaneous axial introduction of the two annular portions into an annular drawing die.

10. The method of claim 1, wherein, with regard to method step f), the two annular portions moving toward one another takes place manually, semiautomatically or fully automatically.

11. The method of claim 1, wherein, with regard to method step g), at a latest after the end position has been reached, the predetermined breaking point between the two annular portions in the form of the produced bearing inner ring and the bearing outer ring breaks.

12. The method of claim 1, wherein, the complete captively mounted rolling bearing subassembly is subjected to heat treatment.

13. The method of claim 1, wherein, a roiling bearing without a cage is produced for rolling bodies, with regard to method step f), and the rolling bodies are introduced into a radial spacing formed between the two annular portions which are moved toward one another.

14. The method of claim 13 for producing a cageless rolling bearing, wherein, in method step g), the transfer of the two annular portions, including the at least one row of rolling bodies, takes place by the further application of force to the end faces of the annular portions and/or to the rolling bodies into an end position such that a complete captively mounted subassembly, comprising a bearing inner ring and of a bearing outer ring, with annular raceways which are arranged radially opposite one another and in which the at least one rolling body row is received positively, is formed.

15. The method of claim 1, wherein one of the two annular portions is produced separately and is conveyed to the other of the two annular portions before reception of the rolling bodies and common forming.

16. The method of claim 1, wherein, with regard to method step d), the axial press forming is carried out as a deep drawing or extrusion of at least one of the two annular portions.

17. The method of claim 1, wherein, with regard to method step d), during the axial press forming, a side of at least one of the two annular portions, which points away from a tool, acquires a contour.

18. A stamping and deep-drawing tool and die for carrying out the method of claim 1.

19. A single-row or multiple-row grooved ball bearing, cylindrical roller bearing or needle bearing, produced according to the method of claim 1.
